(19) United States
(12) Patent Application Publication
(10) Pub. No.: US 2026/0332413 A1
(43) Pub. Date: Oct. 22, 2026

(54) MATRIX-BASED CRYPTOGRAPHIC HARDWARE ACCELERATION WITH SUCCESSIVE ENCRYPTION PARAMETERS

(71) Applicant: IPK Technologies Inc., Del Mar, CA (US)

(72) Inventors: William F. Van Duyne, San Diego, CA (US); Gwain Bayley, Portland, OR (US); William Spazante, San Diego, CA (US); Bruce Robert Meagher, San Diego, CA (US)

(73) Assignee: IPK Technologies Inc., Del Mar, CA (US)

(21) Appl. No.: 19/720,767

(22) Filed: Jun. 25, 2026

Related U.S. Application Data
(63) Continuation-in-part of application No. 19/377,663, filed on Nov. 3, 2025.
(60) Provisional application No. 63/722,787, filed on Nov. 20, 2024.
(60) Provisional application No. 63/778,882, filed on Mar. 27, 2025.

(51) Int. Cl. H04L 9/32; G06F 7/50; G06F 7/523

(52) U.S. Cl. CPC H04L 9/32; G06F 7/50; G06F 7/523

(57) ABSTRACT

A cryptographic hardware accelerator for matrix-based non-substitution-permutation network encryption or decryption of data, including code-based ciphers such as McEliece and lattice-based ciphers such as Kyber and Dilithium. The accelerator includes a matrix operations block configured to perform, in hardware, a multiply and accumulate operation or a multiply and addition operation. In successive iterations of the matrix operations block, the encryption or decryption uses different ciphers, different matrix sizes, or different sets of matrix values. The matrix multiply and accumulate hardware of contemporary graphics processing units, neural processing units, digital signal processors, and central processing units may serve as the matrix operations block, performing both the encryption or decryption and graphics, artificial intelligence, or machine learning workloads. The encryption parameters may be coupled to one or more artificial intelligence functions.

### CROSS-REFERENCE TO RELATED APPLICATIONS

This application is a continuation-in-part of U.S. patent application Ser. No. 19/377,663, entitled “Micro-Architecture for Matrix-Based (Non-Substitution-Permutation Network) Cryptography,” filed on Nov. 3, 2025, which in turn claims the benefit of priority under 35 U.S.C. § 119(e) to U.S. Provisional Patent Application No. 63/722,787, entitled “Systems and Methods for Matrix Based Security,” filed on Nov. 20, 2024, and U.S. Provisional Patent Application No. 63/778,882, entitled “Systems and Methods for Matrix Based Security,” filed on Mar. 27, 2025. The disclosures of each of these prior applications are hereby incorporated by reference in their entirety.

### BACKGROUND OF THE INVENTION

### 1. Field of Invention

The present invention relates to network security and, more particularly, hardware architectures and integrated circuit designs that accelerate matrix-based non-substitution-permutation network encryption or decryption of data.

### 2. Description of Related Art

Conventional cryptographic systems face an evolving threat environment driven by two technical trends. The first trend is the use of artificial intelligence. Modern machine learning models, deep learning networks, and large generative models have been used to read information leaked from a chip during encryption, to recover parts of secret keys from partial information, and to detect patterns in encrypted data that should look random. As artificial intelligence continues to improve, the security margin that designers once counted on for a given cipher and key length keeps shrinking. The second trend is the steady progress of quantum computing. Quantum computers run code-breaking algorithms that classical computers cannot run efficiently, including algorithms that defeat the public-key ciphers used for ordinary internet security such as RSA, Diffie-Hellman, and elliptic curve cryptography, and algorithms that weaken symmetric ciphers such as the Advanced Encryption Standard (AES). Together, these two trends shrink the practical security of widely deployed ciphers and push network security toward post-quantum cryptosystems, which rely on different mathematical problems that are believed to be demanding to solve even for a quantum computer. These trends place a premium on cryptographic systems that can be accelerated in hardware to keep pace with rising data volumes and larger key sizes, and that can introduce uncertainty into the cryptographic state of a system.

Conventional cryptographic hardware addresses these emerging pressures only partially. Substitution-permutation network ciphers, of which the AES is the canonical example, have received the bulk of dedicated hardware acceleration to date and are typically embodied as fixed-function blocks within a system-on-chip, a network interface controller, a storage controller, or a discrete cryptographic coprocessor. Non-substitution-permutation network ciphers that rely on linear-algebraic transformations of large matrices, including the McEliece cryptosystem and its symmetric variants, lattice-based cryptosystems such as Kyber and Dilithium, and other code-based post-quantum candidates, have received comparatively less hardware acceleration attention to date and remain dominated by software implementations and limited research prototypes. Concurrently, modern processors contain substantial blocks of matrix multiply and accumulate hardware originally designed for graphics rendering and for artificial intelligence workloads, including general-purpose graphics processing units, neural processing units, digital signal processors, and central processing units extended with vector and tensor instructions, but this matrix hardware is not architected for cryptographic acceleration.

A need therefore exists in the art for a hardware accelerator architecture that exploits the matrix multiply and accumulate resources of contemporary processors as a unified cryptographic fabric for matrix-based non-substitution-permutation network ciphers, that performs cryptographic operations using a sequenced combination of distinct matrix-operation sub-blocks comprising dedicated hardware circuitry, that introduces uncertainty into the cryptographic state of the system, and that thereby keeps pace with the rising performance demands and the rising adversarial sophistication imposed by artificial intelligence and quantum computing on contemporary cryptographic systems.

### SUMMARY OF THE INVENTION

The present invention addresses these needs by providing a matrix hardware engine for security (“MHE-S”) micro-architecture that accelerates matrix-based non-substitution-permutation network ciphers in dedicated hardware and that introduces uncertainty into the cryptographic state of the system. The MHE-S micro-architecture executes matrix-based cryptography, for example, the McEliece cryptosystem in symmetric or asymmetric form, lattice-based cryptosystems such as Kyber and Dilithium, and other code-based post-quantum candidates, by carrying out linear, arithmetic, logical, and scrambling transformations directly in hardware, representing a departure from the traditional hardware approach of accelerating substitution-permutation network ciphers such as AES.

In certain embodiments, the MHE-S micro-architecture organizes the cryptographic data path as a sequenced combination of distinct matrix-operation sub-blocks of dedicated hardware circuitry, including a linear transformations sub-block, an arithmetic and logic sub-block, and a scramble and permutation sub-block. In certain embodiments, the MHE-S micro-architecture is driven by a sequencer that defines and applies, on a given iteration of the cryptographic data path, a set of encryption parameters comprising the cipher being applied, the matrix size used in the matrix operations, and the set of matrix values used in the matrix operations, and that transitions between sets of encryption parameters at the level of the hardware sub-blocks themselves across iterations of the encryption operation so that the cryptographic state presented to an artificial-intelligence-assisted or quantum-assisted attacker is non-stationary across the data being encrypted. In certain embodiments, the MHE-S micro-architecture exploits the matrix multiply and accumulate resources already present in contemporary graphics processing units, neural processing units, digital signal processors, and central processing units extended with vector and tensor instructions, and repurposes those resources as a unified cryptographic fabric in which the same dedicated hardware circuitry that performs matrix multiply and accumulate for graphics or artificial intelligence workloads also performs matrix multiply and accumulate for matrix-based non-substitution-permutation network ciphers.

The MHE-S micro-architecture supports symmetric and asymmetric non-substitution-permutation network ciphers, key encapsulation, authorization, authentication, hybrid combinations of the foregoing, and successive encryption and successive decryption of subsets of a dataset, of multiple datasets, and of data packets, in each case under encryption parameters that may be the same as or different from the encryption parameters used in any preceding or succeeding iteration, and is adaptable to next-generation cryptographic workloads driven by the post-quantum transition.

In an embodiment of the invention, a cryptographic hardware accelerator for encryption or decryption of data, comprises: a matrix operations block configured to perform, in hardware, at least one of (i) a multiply/accumulate operation or (ii) a multiply and addition operation, as part of the encryption or decryption of a first unit of data and a second unit of data, wherein the encryption or decryption of the first unit of data and the second unit of data uses, in the matrix block, at least one of (a) a first cipher and a second cipher, (b) a first matrix size and a second matrix size, or (c) a first set of matrix values and a second set of matrix values. The first cipher may be a McEliece cryptosystem comprising one or more of (a) an asymmetric McEliece cipher, (b) a symmetric McEliece cipher, or (c) a McEliece variant cipher. The first cipher may also be AES. The first cipher may also be a lattice-based non-substitution-permutation network cipher. The cryptographic hardware accelerator may further comprise at least one of (a) a sequencer implemented in hardware and configured to control the matrix operations block, (b) a scramble sub-block of the matrix operations block, the scramble sub-block being implemented in hardware and configured to perform a scramble operation on the data, or (c) a permutation sub-block of the matrix operations block, the permutation sub-block being implemented in hardware and configured to perform a permutation operation on the data. The second cipher may be different from the first cipher, the second matrix size may be different from the first matrix size, or the second set of matrix values may be different from the first set of matrix values. The matrix operations block may be implemented as part of a hardware core, a graphics processing unit (GPU), a digital signal processor (DSP), a neural processing unit (NPU), a central processing unit (CPU), a field-programmable gate array (FPGA), an application-specific integrated circuit (ASIC), a chiplet, a multi-chip module, a chip-stacking environment, or a memory controller. The matrix operations block may be assisted by one or more processor instructions.

In another embodiment of the invention, a method for encryption or decryption of data, comprises: performing, in hardware by a matrix operations block of a cryptographic hardware accelerator, at least one of (i) a multiply/accumulate operation or (ii) a multiply and addition operation, as part of the encryption or decryption of a first unit of data and a second unit of data, wherein the encryption or decryption of the first unit of data and the second unit of data uses, in the matrix operations block, at least one of (a) a first cipher and a second cipher, (b) a first matrix size and a second matrix size, or (c) a first set of matrix values and a second set of matrix values. The first cipher may be a McEliece cryptosystem comprising one or more of (a) an asymmetric McEliece cipher, (b) a symmetric McEliece cipher, or (c) a McEliece variant cipher. The first cipher may be AES. The first cipher may also be a lattice-based non-substitution-permutation network cipher. The method may further comprise at least one of (a) controlling the matrix operations block by a sequencer implemented in hardware, (b) performing, in hardware by a scramble sub-block of the matrix operations block, a scramble operation on the data, or (c) performing, in hardware by a permutation sub-block of the matrix operations block, a permutation operation on the data. The second cipher may be different from the first cipher, the second matrix size may be different from the first matrix size, or the second set of matrix values may be different from the first set of matrix values. The matrix operations block may be implemented as part of a hardware core, a graphics processing unit (GPU), a digital signal processor (DSP), a neural processing unit (NPU), a central processing unit (CPU), a field-programmable gate array (FPGA), an application-specific integrated circuit (ASIC), a chiplet, a multi-chip module, a chip-stacking environment, or a memory controller. The matrix operations block may be assisted by one or more processor instructions.

In yet another embodiment of the invention, a processor comprises: a matrix multiply and accumulate hardware block configured to perform, in hardware, at least one of (i) a matrix multiply operation or (ii) a matrix multiply and accumulate operation, wherein the matrix multiply and accumulate hardware block is configured to perform the at least one of (i) the matrix multiply operation or (ii) the matrix multiply and accumulate operation as part of both (a) at least one of a graphics processing function, an artificial intelligence function, a machine learning function, or a digital signal processing function, and (b) encryption or decryption of data, and wherein the encryption or decryption of data uses, in the matrix multiply and accumulate hardware block, at least one of (a) a first cipher and a second cipher, (b) a first matrix size and a second matrix size, or (c) a first set of matrix values and a second set of matrix values. The processor may comprise at least one of a graphics processing unit, a neural processing unit, a digital signal processor, or a central processing unit extended with vector or tensor instructions. The first cipher may be a McEliece cryptosystem comprising one or more of (a) an asymmetric McEliece cipher, (b) a symmetric McEliece cipher, or (c) a McEliece variant cipher. The first cipher may be AES.

The present invention offers several substantial architectural advantages that address the limitations of conventional cryptographic systems and hardware accelerators in light of the artificial intelligence and quantum computing pressures placed on contemporary cryptographic systems. The MHE-S micro-architecture provides dedicated hardware acceleration for matrix-based non-substitution-permutation network ciphers, including the McEliece cryptosystem in symmetric and asymmetric form, lattice-based cryptosystems such as Kyber and Dilithium, and other code-based post-quantum candidates, that have received comparatively less hardware acceleration attention to date than the substitution-permutation network ciphers exemplified by AES, and does so by organizing the cryptographic data path as a sequenced combination of distinct matrix-operation sub-blocks of dedicated hardware circuitry, including a linear transformations sub-block implementable as a systolic array of complementary metal-oxide-semiconductor transistors, an arithmetic and logic sub-block implementable as a network of full adders realized in complementary metal-oxide-semiconductor transmission and logic gates, and a scramble and permutation sub-block implementable as an array of six-transistor static random access memory cells with supporting complementary metal-oxide-semiconductor logic gates.

The MHE-S micro-architecture introduces uncertainty into the cryptographic state of the system by transitioning between encryption parameters, including the cipher, the matrix size, and the matrix values, at the level of the hardware sub-blocks performing the matrix operations themselves rather than at the level of bitstream regeneration, crossbar rewriting, software instruction issue, or host-side kernel invocation, with the result that the cryptographic state presented to an artificial-intelligence-assisted or quantum-assisted attacker is non-stationary across the data being encrypted and resists pattern-extraction, side-channel, downgrade, and partial-key-recovery attacks that exploit the persistence of any one cipher, key length, or key value. In addition, the MHE-S micro-architecture exploits the matrix multiply and accumulate resources already present in contemporary graphics processing units, neural processing units, digital signal processors, and central processing units extended with vector and tensor instructions, and repurposes those resources as a unified cryptographic fabric, eliminating the silicon area, power, and integration overhead that would otherwise be incurred by duplicating dedicated cryptographic blocks alongside the matrix hardware that contemporary processors already contain.

The MHE-S micro-architecture also offers operational advantages that flow from its hardware-block organization and from its support for dynamic encryption parameters. The architecture is suitable for symmetric and asymmetric cryptographic modes and supports key encapsulation, authentication, authorization, hybrid cryptographic combinations, and successive encryption and successive decryption of subsets of a dataset, of multiple datasets, and of data packets, in each case under encryption parameters that may be the same as or different from the encryption parameters used in any preceding or succeeding iteration. Because parameter transitions occur at the level of the hardware sub-blocks rather than at the level of higher-layer renegotiation or bitstream reconfiguration, the data path through the MHE-S micro-architecture is not interrupted when the cipher, the matrix size, or the matrix values change between iterations of the encryption operation, and the architecture accordingly avoids the renegotiation handshakes and the cryptographic-state teardown and rebuild operations that conventional accelerators require to switch parameters between iterations. The architecture is replicable and scalable, supporting parallel deployment of multiple MHE-S cores within a single processor, across chiplets in a multi-chip module, across stacked dies in a chip-stack, and across multiple neural processing units coupled through a pod interface, so that the architecture can be deployed in communications, storage, embedded, and high-performance computing environments where energy efficiency, throughput, or latency is paramount, and so that cryptographic acceleration can occur alongside, and even within, the same hardware fabric performing graphics, artificial intelligence, or general-purpose workloads. By providing high-performance hardware acceleration of matrix-based non-substitution-permutation network ciphers and by introducing hardware-block-level uncertainty into the cryptographic state of the system, the MHE-S micro-architecture serves as a foundational building block for robust, energy-efficient, and future-proof data protection in modern digital systems facing the artificial intelligence and quantum computing threat environment.

The preceding paragraphs have been provided as a general introduction and are not intended to limit the scope of the following claims. The embodiments described and further advantages will be best understood by reference to the following detailed description in conjunction with the accompanying drawings.

### BRIEF DESCRIPTION OF THE DRAWINGS

For a complete understanding of the present invention and its advantages, reference is now made to the ensuing descriptions taken in connection with the accompanying drawings briefly described as follows:

FIG. 1 illustrates a matrix hardware engine for security (MHE-S) micro-architecture according to an embodiment of the invention.

FIG. 2A and FIG. 2B illustrate encryption/encode and decryption/decode flows for symmetric McEliece encryption using MHE-S.

FIG. 2C and FIG. 2D illustrate successive encryption and successive decryption flows performed by the MHE-S micro-architecture, in which one or more encryption parameters are changed across successive iterations of the matrix operations block.

FIG. 3 illustrates a processor system incorporating one or more MHE-S cores according to an embodiment of the invention.

FIG. 4 illustrates an Intelligent PolyKey (IPK) frame structure according to an embodiment of the invention.

FIG. 5 presents a functional categorization of the MHE-S micro-architecture's blocks, as introduced in FIG. 1.

FIG. 6 illustrates exemplary hardware implementations of key matrix operations performed by the MHE-S micro-architecture according to an embodiment of the invention.

FIG. 7 illustrates a neural processing unit (NPU) micro-architecture according to an embodiment of the invention.

### DETAILED DESCRIPTION OF PREFERRED EMBODIMENTS

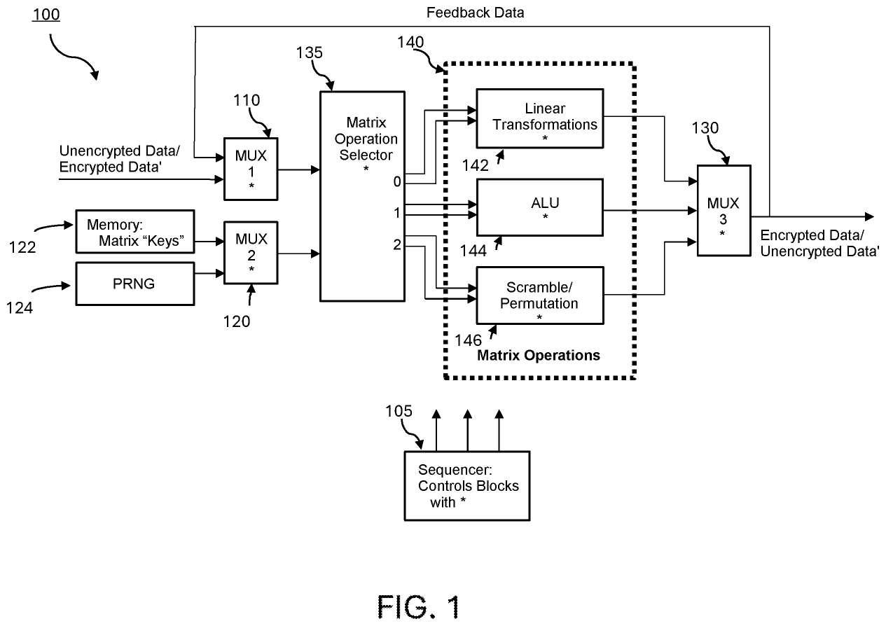

Aspects of the present invention are best understood by reference to the detailed description set forth herein and accompanying FIGS. 1-7. However, it should be understood that the following description, while indicating preferred embodiments and numerous specific details, is given by illustration only and should not be considered limiting. Changes and modifications may be made without departing from the spirit and scope thereof, and the present invention herein includes all such modifications.

The present invention is a matrix hardware engine for security (“MHE-S”) that accelerates matrix-based non-SPN encryption and decryption relative to software implementations and that introduces uncertainty into the cryptographic state of the system. The MHE-S performs matrix operations (MOs) on data through dedicated hardware circuitry organized as a sequenced combination of distinct matrix-operation sub-blocks. The MOs include but are not limited to linear transformations, logical operations, arithmetic operations, bits or byte shift or reversal, and scramble and permutation functions. The linear transformations may include multiply, multiply/accumulate, addition, change of basis, inner product, quantization, scaling, rotations, and shearing. In some embodiments, the encryption techniques may use error correction codes. In some embodiments, the encryption may use integer or real matrices that may be orthogonal, or complex matrices that may be unitary. In certain embodiments, the MHE-S exploits the matrix multiply and accumulate resources already present in contemporary graphics processing units, neural processing units, digital signal processors, and central processing units extended with vector and tensor instructions, and repurposes those resources as a unified cryptographic fabric in which the same dedicated hardware circuitry that performs matrix multiply and accumulate for graphics or artificial intelligence workloads also performs matrix multiply and accumulate for matrix-based non-SPN cryptography or AES. In certain embodiments, the MHE-S supports successive encryption and successive decryption of subsets of a dataset, of multiple datasets, and of data packets, in each case under encryption parameters that may be the same as or different from the encryption parameters used in any preceding or succeeding iteration, the encryption parameters comprising the cipher being applied, the matrix size used in the matrix operations, and the set of matrix values used in the matrix operations, with the result that the cryptographic state presented to an artificial-intelligence-assisted or quantum-assisted attacker is non-stationary across the data being encrypted. The MHE-S micro-architecture applies to all communication and non-communication environments, including but not limited to all wired and wireless communications, data center, and storage at any open systems interconnection (OSI) layer.

In embodiments of the invention, the hardware micro-architecture described herein implements matrix-based non-SPN ciphers, including the McEliece cryptosystem in symmetric and asymmetric form, lattice-based cryptosystems such as Kyber and Dilithium, and other code-based post-quantum candidates that rely on linear-algebraic transformations of large matrices. Because SPNs use a series of substitution (S-Boxes) and permutation (P-Boxes) layers to encrypt data, there is significant processing overhead due to multiple feedback iterations, or rounds. Non-SPN ciphers do not require substitution or permutation feedback iterations. As an example of an SPN cipher, AES is always a symmetric cipher in which a common secret key is used between sender and receiver. As an example of a non-SPN cipher, McEliece may function as an asymmetric or symmetric cipher in which either a public/private key (asymmetric) or a common secret key (symmetric) is used between sender and receiver. When comparing the software implementations of AES and McEliece, the AES cipher will take significantly longer to encrypt or decrypt data than the McEliece cipher due to the multiple rounds required for the substitution-permutation network. Hardware acceleration of SPN ciphers, and specifically AES, is more competitive with the software implementations of non-SPN ciphers. However, the hardware acceleration of non-SPN ciphers provided by the MHE-S micro-architecture yields performance, efficiency, and energy benefits over not only non-SPN encryption via software but also SPN encryption in both software and hardware, and additionally introduces parameter uncertainty into the cryptographic state of the system so that an artificial-intelligence-assisted or quantum-assisted adversary cannot rely on the persistence of any one cipher, key length, or key value as data is encrypted. As used herein, the term “McEliece cryptosystem” refers to any cryptosystem based on McEliece, whether symmetric or asymmetric, and includes all variants of McEliece, whether currently known or developed in the future.

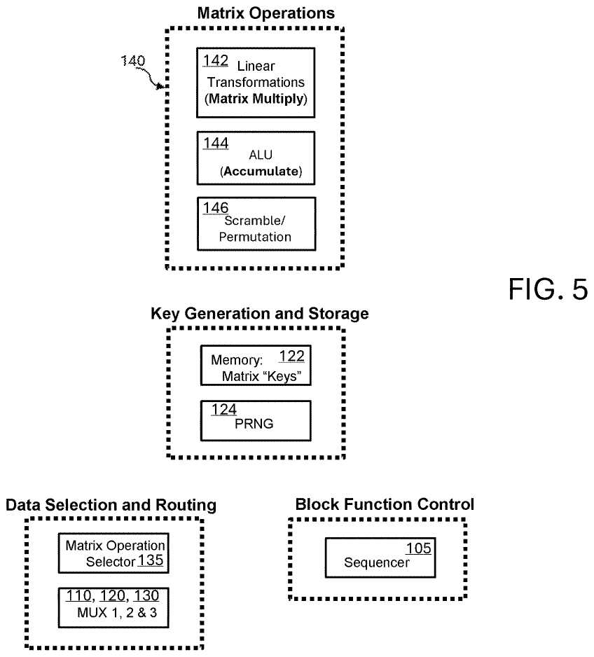

FIG. 1 illustrates an MHE-S micro-architecture core 100 according to an embodiment of the invention, which may be implemented in any chip. The MHE-S micro-architecture 100 comprises several modular components, or blocks, each interconnected to enable accelerated, flexible, and secure matrix-based cryptographic processing. Unencrypted Data may be input to the MHE-S and by the application of a series of matrix operations, the encoded output is Encrypted Data. Also, Encrypted Data' may be input to the MHE-S and by the application of a series of matrix operations that undo the encoded matrix operations, the decoded output is Unencrypted Data'. FIG. 5, described below with reference to that figure, categorizes the blocks of FIG. 1 by function and identifies which blocks are most efficiently realized in dedicated hardware and which may be realized in software or firmware.

As used herein, the term “block” refers to a modular hardware component, or a combination of hardware and/or software including software alone, that is functionally grouped to perform one or more specific tasks within the larger system. The blocks are configured to interact with other blocks or components via well-defined interfaces to perform the overall functions of the system. The system may be implemented as a self-contained or centralized system, or a distributed system where one or more blocks are located on different networked components. The term “block” may also indicate one or more functions.

A sequencer block 105 acts as a scheduling mechanism for the core 100 with specific control over multiplexers MUX1 110, MUX2 120, and MUX3 130, matrix operation selector 135 and matrix operations block 140. The multiplexors, MUX1 110, MUX2 120, and MUX3 130 allow for the proper data path selection as controlled by the sequencer block 105. MUX1 110 either selects Unencrypted Data/Encrypted Data' as per the sequencer block 105.

The matrix operations block 140 comprises three sub-blocks: a linear transformations 142, an arithmetic and logic unit (ALU) 144, and a scramble/permutation 146. The chosen matrix operation(s) is(are) set by the sequencer block 105. The linear transformations block 142 performs a variety of matrix-based linear transformations including but not limited to multiply, multiply/accumulate, addition, change of basis, inner (dot) product, quantization, scaling, rotations, and shearing. The sub-blocks 142, 144, and 146, including any subsets and portions thereof, may be implemented in hardware, software, or a combination of hardware and software. In an embodiment of the invention, at least the multiply/accumulate operation (a single, combined operation) or the multiply and the addition operations (two separate steps), are implemented in hardware to accelerate a non-SPN cryptosystem.

The ALU block 144 implements Boolean operations, addition, and bit/byte manipulations, e.g., shifting and reversal. Some non-SPN ciphers may require a cyclic redundancy check (CRC) or hash function. The CRC or hash may be implemented using the ALU 144, dedicated hardware, or software. The scramble/permutation block 146 allows bit value changes as defined by a scramble table and bit shuffling as defined by a permutation table. In certain embodiments, the scramble and permutation functions within the system can be expanded to operate on multi-bit or multi-byte units of data, rather than restricting their scope to individual bits. The techniques for implementing each of the operations within the matrix operations block 140, including those detailed above, are well understood by one of ordinary skill in the art. In some embodiments, one or more matrix operations may be implemented and executed as an atomic operation.

In an embodiment of the invention, matrix multiplication is implemented using high-performance hardware structures such as systolic arrays or linear feedback shift registers (LFSRs) for efficiency and scalability. The scramble operation is implemented with a dedicated memory containing the scramble table bits that are XOR'd bit-by-bit with the data to be encrypted to realize the scramble function (i.e., change appropriate bit values). The permutation operation is implemented with a dedicated memory containing the permutation table of shuffled addresses that are used to read the data to be encrypted in the permuted order. In other embodiments, an LFSR may be used to generate the scramble and permutation tables.

A memory block 122 stores matrix values or “keys” used in linear transformation, arithmetic, and logic operations in addition to scramble/permutation table values used by the scramble/permutation block 146 for data obfuscation. Accordingly, memory block 122 acts as a central storage unit for all the numerical values, keys, and mapping tables that the other hardware blocks need to perform their cryptographic functions efficiently and correctly. By keeping these elements in dedicated, fast-access memory, the MHE-S core 100 ensures that encryption, decryption, and data obfuscation can proceed rapidly and securely, without having to fetch critical values from slower, external storage.

A pseudo-random number generator (PRNG) block 124 implements one or more algorithms to produce matrix values or “keys” used in linear transformation, arithmetic and logic operations in addition to scramble or permutation table values used by the scramble/permutation block 146 for data obfuscation. The design and implementation of the PRNG block 124, as described herein, uses a linear feedback shift register (LFSR).

MUX2 120 selects Matrix “Key” or PRNG Key that will be used for the matrix operations 140 as per the sequencer block 105 based on the needs of the particular matrix operation and the desired balance between security, performance, and resource usage. For scrambling operations, permutation operations, and error correcting code (ECC) encoding, the scramble table values, permutation table values and ECC encoding matrix values use the PRNG 124 or precomputed matrices stored in memory 122.

The matrix operation selector block 135 routes the input data (Unencrypted Data/Encrypted Data′ or Feedback Data) and matrix operands (Matrix “Keys” or RNG/PRNG Keys) to the appropriate matrix operation in the matrix operations block 140 as per the sequencer block 105. MUX3 130 selects the matrix operations result (linear transformation, ALU, scramble/permutation, or a combination thereof) as per the sequencer block 105.

The sequencer block 105 is control logic that orchestrates the entire encryption and decryption process. Its primary function is to manage the flow of data and operations within the core by coordinating other hardware blocks according to a preconfigured schedule. In practical terms, the sequencer block 105 is what ensures that each step, in the cryptographic system chosen, happens in the correct sequence, with the right inputs, outputs, and intermediate results routed to the appropriate processing units at the right time. In an embodiment of the invention, the sequencer block 105 is implemented as a programmable state machine that corresponds to the cryptographic algorithm's requirements. Each clock cycle, the sequencer advances through its sequence, generating the control signals that set the multiplexers, enable the correct matrix operation, and route data through the core 100. For example, with symmetric McEliece encryption, the sequencer 105 is programmed to perform three matrix operations in succession: a scramble, ECC encode and permutation. The scramble table, the ECC matrix values, and permutation tables are stored in memory 122. The scramble table could have been generated by the PRNG 124. For the scramble operation the sequencer 105 sets MUX1 110 to accept the initial Unencrypted Data, sets MUX2 120 to access the scramble table in memory 122, selects, via the matrix operations selector block 135, the scramble function from the scramble/permutation block 146 and the scramble is performed. The sequencer 105 then directs the ALU 144 to calculate the CRC on the scrambled data which will be used for decryption. For the second matrix operation, the ECC encode, the sequencer 105 sets MUX1 110 to select the feedback path, sets MUX2 120 to access the encode matrix values from memory 122 and selects, via the matrix operations selector block 135, the linear transformations block 142 to perform the matrix multiply and accumulate of the feedback data and the matrix values in memory 122. For the third matrix operation, the permutation, the sequencer 105 sets the MUX1 110 to accept feedback data, MUX2 120 to access the permutation table from memory 122 selects, via the matrix operations selector block 135, the permutation function from the scramble/permutation block 146 and the permutation is performed.

The MHE-S micro-architecture core 100 may be implemented in any hardware, including but not limited to any processor chip, memory chip, dedicated MHE-S chip, field programmable gate array (FPGA), or application specific integrated circuit (ASIC). In some embodiments, an MHE-S core may be implemented in future processors and tailored to optimize matrix-based security functions. In some embodiments, the MHE-S core may be replicated on any chip to enable parallel processing or redundancy. In some embodiments, the MHE-S core may be added to any processor for the hardware accelerated security of data, audio, video, or images. In some embodiments, the MHE-S core may coexist with SPN encryption cores, thus allowing flexibility to use either or both non-SPN and SPN cores.

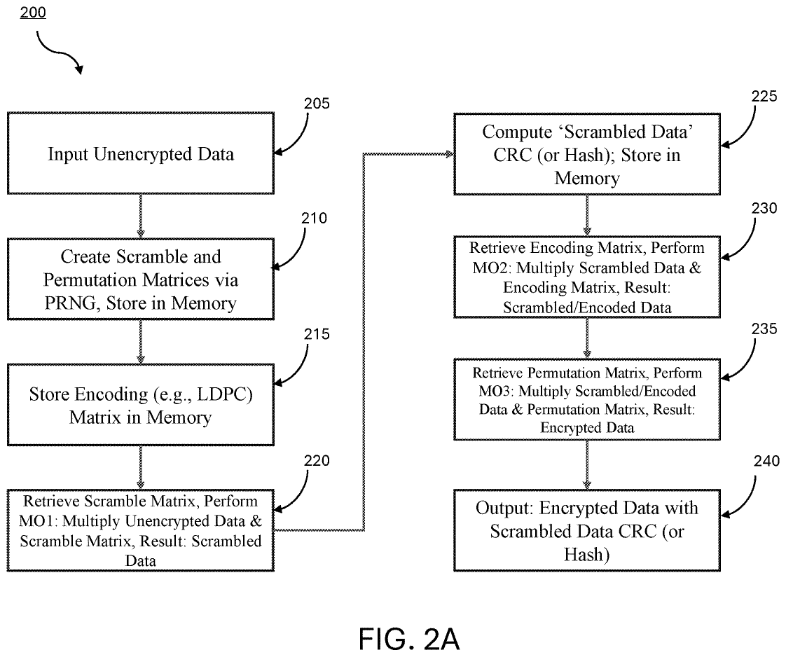

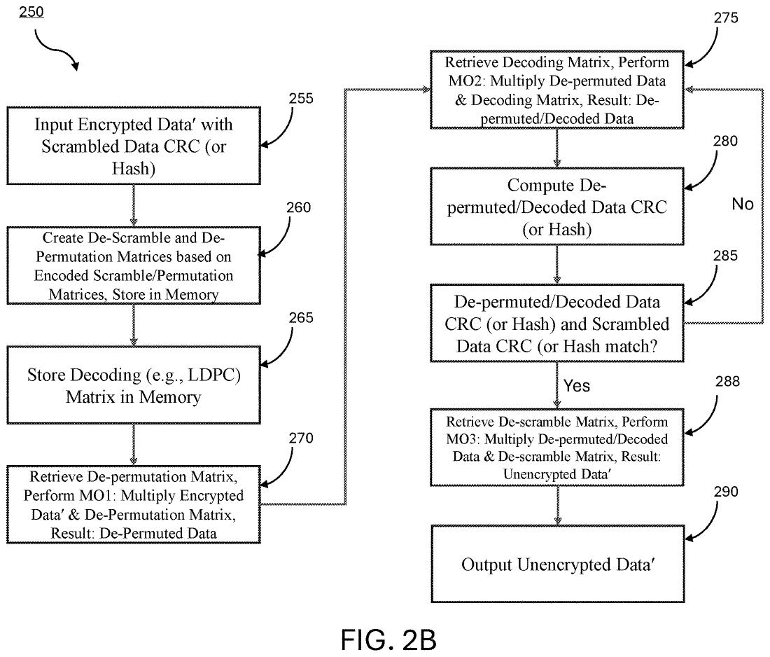

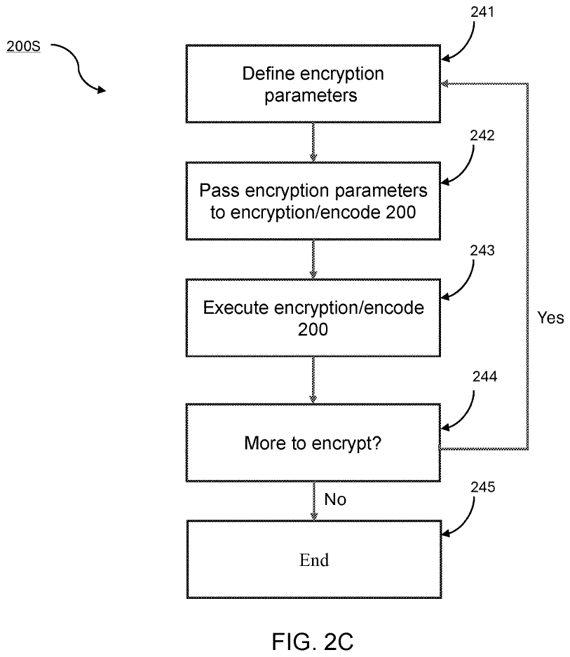

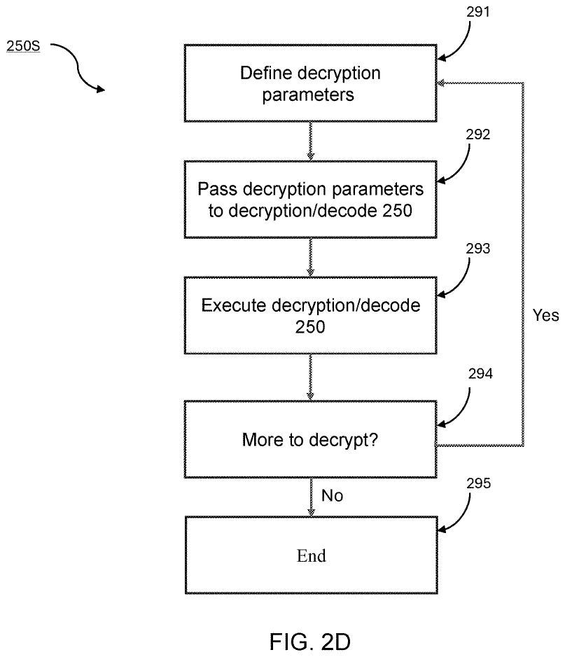

FIG. 2A and FIG. 2B illustrate encryption/encode and decryption/decode flows for symmetric McEliece encryption using the MHE-S core 100 shown in FIG. 1. The encryption/encode flow 200 (FIG. 2A) begins with step 205, where the unencrypted data is input into the system. Step 210 involves creating the scramble and permutation matrices using the PRNG 124 and storing these matrices in memory 122 for subsequent use. In step 215, an encoding matrix, such as a low-density parity-check (LDPC) matrix, is stored in memory 122. Step 220 retrieves the scramble matrix and performs the first matrix operation (MO1), multiplying the input unencrypted data by the scramble matrix to produce scrambled data. Step 225 calculates a cyclic redundancy check (CRC) or hash of the “scrambled data,” storing the result in memory 122 for later verification. In step 230, the encoding matrix is retrieved, and the second matrix operation (MO2) is executed, multiplying the scrambled data by the encoding matrix to generate scrambled and encoded data. Step 235 retrieves the permutation matrix and performs the third matrix operation (MO3), multiplying the scrambled and encoded data by the permutation matrix to yield scrambled, encoded, and permuted data, which constitutes the final encrypted data. The system 100 outputs (step 240) the encrypted data along with the previously stored scrambled data CRC or hash. This matrix-based process, using randomization, integrity checks, and linear algebra, delivers robust, flexible, and potentially quantum-resistant encryption, making it directly applicable to McEliece, its variants, and other emerging non-SPN post-quantum ciphers. The hash or the CRC provides a sufficient check that decryption has completed.

The counterpart decryption/decode flow 250 (FIG. 2B) commences with step 255, where Encrypted Data' accompanied by the scrambled data CRC or hash is input. Then, the encoding matrix operations are performed in reverse order with the counterpart de-permutation, decoding (for example, LDPC codes) and de-scramble matrices. Step 260 generates de-scramble and de-permutation matrices based on the encoded scramble and permutation matrices, storing them in memory 122. In step 265, a decoding matrix (e.g., LDPC matrix) is stored in memory 122. Step 270 retrieves the de-permutation matrix and performs the first matrix operation (MO1), multiplying the input Encrypted Data' by the de-permutation matrix to produce de-permuted data. In step 275, the decoding matrix is retrieved, and the second matrix operation (MO2) is executed, multiplying the de-permuted data by the decoding matrix to yield de-permuted and decoded data. Step 280 computes a CRC or hash of the de-permuted and decoded data. In step 285, this computed CRC or hash is compared to the scrambled data CRC or hash that accompanied the Encrypted Data'; if they match, the process proceeds to step 288; if not, the process returns to step 275 for another iteration of decoding. In step 288, the de-scramble matrix is retrieved, and the third matrix operation (MO3) is performed, multiplying the de-permuted and decoded data by the de-scramble matrix to produce de-permuted, decoded, and de-scrambled data, which constitutes the final Unencrypted Data'. Step 290 outputs the Unencrypted Data', ending the decryption/decode flow.

Having detailed the encryption/encode and decryption/decode workflows enabled by the MHE-S micro-architecture core, where unencrypted data is converted to encrypted data and vice versa through a carefully orchestrated series of matrix processing, randomization, and integrity verification steps, it is clear that the MHE-S micro-architecture is both robust and highly adaptable.

The present invention's modular architecture is not only self-contained but also readily scalable: one or more MHE-S cores can be integrated as hardware accelerators into a variety of processor chips, including CPUs, NPUs, GPUs, digital signal processors (DSPs), and other specialized or custom processors. In some embodiments, one or more MHE-S cores may be implemented as a chiplet and used as part of a multi-chip module (MCM) or in a chip stacking configuration using processes such as through silicon vias (TSVs). In some embodiments, the one or more MHE-S cores could be implemented in a standalone chip. This integration enables flexible, high-performance matrix-based cryptographic operations directly at the hardware level, making accelerated, quantum-resistant encryption and decryption widely accessible across both embedded and general-purpose computing platforms.

As described above, the encryption/encode flow 200 and decryption/decode flow 250 apply to a single dataset. However, the micro-architecture 100 is flexible so that it can be applied iteratively to subsets of a dataset, multiple datasets, or data packets. In other words, the MHE-S core 100 is not limited to a single-pass operation, and can instead be iterated over and over again, with each iteration operating on a different chunk of input data, and in an embodiment of the invention, under a different respective set of encryption parameters from the iteration that came before it. This iterative encryption technique is referred to as successive encryption. As used herein, a data unit or unit of data is any structured, measurable amount of digital information that can be treated as a single entity for encryption or decryption processing.

As used herein, the term “successive encryption” refers to the application of one or more encryption operations to data in which one or more encryption parameters used to encrypt the data are changed at one or more times, including without limitation iterative invocation of an encryption operation on successive units of input data, where each invocation operates on a respective unit of input data and is performed under a respective set of encryption parameters, and where the respective sets of encryption parameters used across two or more invocations may be the same as or different from one another. Encryption parameters within the meaning of successive encryption include without limitation the cipher being applied, the matrix size, including the number of rows and columns of the matrix and the corresponding key length, the matrix values, including the content of one or more keys, the error correction code type, the scramble matrix, the ECC encode matrix, the permutation matrix, and any other parameter that affects the cryptographic transformation applied to the data. Successive encryption includes without limitation iterative invocation of the encryption operation on subsets of a single dataset, iterative invocation of the encryption operation on multiple datasets, and iterative invocation of the encryption operation on data packets, in each case under encryption parameters that may be the same as or different from the encryption parameters used in any preceding or succeeding invocation. The term “successive decryption” refers to the corresponding inverse operation, in which one or more decryption parameters used to decrypt encrypted data are changed at one or more times and are selected to mirror the encryption parameters under which the corresponding encrypted data was originally encrypted.

As used herein, the term “encryption parameters” refers to one or more parameters that, individually or in combination, determine the cryptographic transformation that is applied to data, including without limitation the cipher being applied, the matrix size, including the number of rows and columns of one or more matrices used in matrix operations and the corresponding key length, the matrix values, including the content of one or more keys used in the matrix operations, the error correction code type, the scramble matrix, the ECC encode matrix, the permutation matrix, and any other parameter that affects the cryptographic transformation applied to the data. The term “decryption parameters” refers to the corresponding inverse parameters used to recover the original data from data that has been subjected to one or more encryption operations performed under one or more encryption parameters.

FIG. 2C illustrates successive encryption 200S using the micro-architecture 100 with a variety of encryption parameters to datasets in whole or part. For successive encryption 200S, the encryption/encode 200 is called for each specific encryption iteration, respective parameters are passed to encryption/encode 200 and it implements a specific encryption algorithm such as symmetric McEliece. In an exemplary embodiment, all the symmetric key parameters are passed to 200, namely the scramble, ECC encode and permutation matrix values are defined, in addition to the ECC type. Successive encryption 200S starts with defining all the encryption parameters, step 241, and passing them to encryption/encode 200, step 242. Step 243 executes encryption/encode 200. Step 244 repeats the encryption/encode process 200 at step 241 until all data has been encrypted, step 245.

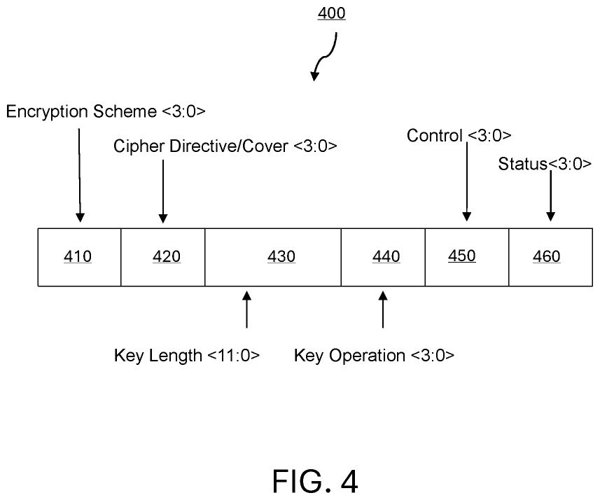

In certain embodiments, the encryption parameters defined at step 241 are sourced from the pseudorandom number generator block 124, are derived from one or more fields of the Intelligent PolyKey (IPK) frame 400 described below with reference to FIG. 4, including without limitation the encryption scheme field 410, the cipher directive field 420, the key length field 430, and the key operation field 440, are supplied to the matrix operations block 140 from a source external to the micro-architecture 100, or are generated by the sequencer 105 according to a programmed schedule. The schedule may be defined in any of various forms including without limitation a schedule that transitions the encryption parameters on a per-packet basis, on a per-N-packet basis where N is any positive integer, on a per-byte-count basis, on a per-iteration basis, in response to one or more threat indicators received from a security-monitoring component external or internal to the micro-architecture 100, in response to one or more events of a higher-layer protocol, or in any combination of the foregoing.

FIG. 2D illustrates successive decryption 250S performing the corresponding decryptions relative to the successive encryption 200S. Successive decryption 250S starts with defining all the decryption parameters, step 291, and passing them to decryption/decode 250, step 292. Step 293 executes decryption/decode 250. Step 294 repeats the decryption/decode process 250 at step 291 until all data has been decrypted, step 295. The sequencer 105 functionality may be expanded to perform the successive encryption and decryption functions according to a schedule using the preferred embodiment implementation of a programmable state machine incorporating the additional processes.

In certain embodiments, the cipher specified by the encryption parameters defined at step 241 is selected from a group including without limitation a symmetric McEliece cipher, an asymmetric McEliece cipher, a McEliece variant cipher, a lattice-based cipher such as Kyber or Dilithium, a code-based cipher, and any combination thereof, and in certain other embodiments where successive changes to ciphers, matrix sizes, or matrix values are utilized, the cipher is selected to include one or more substitution-permutation network ciphers such as AES or Ascon in addition to or instead of one or more non-SPN ciphers. The encryption parameters used across two or more iterations of the successive encryption 200S, including the cipher, the matrix size, and the matrix values, may be the same as or different from one another. The successive decryption 250S selects, at step 291, decryption parameters that mirror the encryption parameters defined at the corresponding step 241 of the successive encryption 200S from which the data being decrypted originated. In other embodiments where successive changes to ciphers, matrix sizes, or matrix values are used, the micro-architecture 100 in whole or in part is applied to SPN encryption in addition to non-SPN encryption where matrix operations are performed.

Because the encryption parameter transitions of the successive encryption 200S and the successive decryption 250S occur at the level of the matrix operations block 140 and its sub-blocks, including the linear transformations sub-block 142, the ALU sub-block 144, and the scramble and permutation sub-block 146, the data path through the micro-architecture 100 is not interrupted by a transition between sets of encryption parameters, and the cryptographic state of the micro-architecture 100 is accordingly non-stationary across the data being encrypted. In an embodiment, the sequencer 105 implements the successive encryption and successive decryption schedules as additional states of a programmable state machine that is configured to load new encryption parameters into the matrix operations block 140 between successive iterations of the encryption/encode process 200 or the decryption/decode process 250 without flushing any portion of the data path that is not consumed by the new parameters, with the result that the throughput of the micro-architecture 100 is preserved across parameter transitions, and that the cipher, the matrix size, and the matrix values presented to an artificial-intelligence-assisted or quantum-assisted attacker change.

In certain embodiments, the iterative invocation of the encryption/encode flow 200 by the successive encryption flow 200S, and the iterative invocation of the decryption/decode flow 250 by the successive decryption flow 250S, may be driven at any of various granularities, with each iteration of the corresponding loop operating on a respective unit of input data and being performed under a respective set of encryption parameters that may be the same as or different from the encryption parameters of any preceding or succeeding iteration. In some embodiments, the unit of input data of a given iteration is a subset of a larger dataset, including without limitation a portion of a file, a portion of a video frame, a portion of an audio sample, a portion of an image, a portion of a database record, a portion of a memory page, or a portion of any other logical block of data, such that successive iterations of the loop encrypt successive subsets of the same larger dataset under encryption parameters that may differ from one subset to the next.

In some embodiments, the unit of input data of a given iteration is a data packet, including without limitation a network packet, a frame, a cell, a transport-layer segment, an application-layer message, or any other unit of data communicated between a sender and a receiver, and successive iterations of the loop encrypt successive packets under encryption parameters that may differ from one packet to the next. In some embodiments, the unit of input data of a given iteration is a data packet, including without limitation a network packet, a frame, a cell, a transport-layer segment, an application-layer message, or any other unit of data communicated between a sender and a receiver, and successive iterations of the loop encrypt successive packets under encryption parameters that may differ from one packet to the next. The foregoing granularities are not mutually exclusive, and in some embodiments the unit of input data of a given iteration is selected dynamically by the sequencer 105 from among two or more of the foregoing granularities according to a programmed schedule or in response to one or more events occurring during operation of the micro-architecture 100.

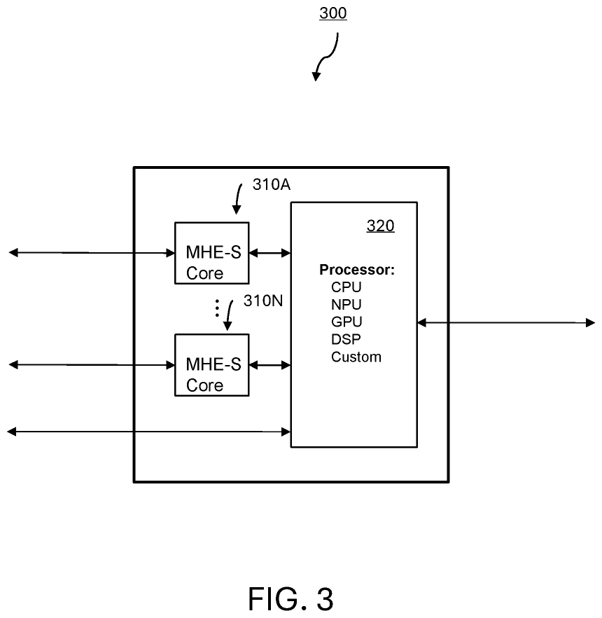

FIG. 3 illustrates a processor 300 with MHE-S cores 310A-N according to an embodiment of the invention. The processor 320 may be of any conventional type, such as a CPU, NPU, GPU, DSP, or may comprise custom logic. Each MHE-S core 310 can be added to a processor chip in a variety of configurations, reflecting the flexibility of the micro-architecture. In some embodiments, the MHE-S cores 310A-N, where N is any positive integer, are integrated onto the same die as the processor 320, enabling direct acceleration of matrix-based cryptographic functions within the main processor pipeline. The varied integration options depicted in FIG. 3, each identified by their respective reference numerals, demonstrate the adaptability of the MHE-S micro-architecture to a wide range of semiconductor platforms and packaging technologies, ensuring broad applicability across computing devices and architectures.

FIG. 4 illustrates an Intelligent Poly Key (IPK) frame structure 400 according to an embodiment of the invention. The IPK frame structure 400 defines two types of fields, cryptographic and control/status. The cryptographic fields are encryption scheme 410, cipher directive 420, key length 430, and key operation 440. The encryption scheme 410 may identify a variety of established ciphers and associated keys. The cipher directive field 420 may identify a variety of custom or emerging ciphers including variants of established ciphers. As an example of a variant of an established cipher, McEliece performs one each of scramble, encode, and permutation operations. A McEliece variant could include more than one of the scramble, encode, and permutation operations. The key length field 430 identifies a variety of key bit lengths that may be used with the ciphers. The key operation 440 field identifies a variety of logical or arithmetic operations that may be performed on key content, in addition to a new key definition. The control field 450 may define system management functions in addition to coupling encryption to specific functions such as forward error correction (FEC), modulation, or AI. The status field 460 reports operational outcomes, such as successful processing, errors, or readiness states of the sender or receiver.

The cryptographic fields enable dynamic, adaptable encryption by allowing successive changes to the encryption process, a feature detailed further in Applicant's U.S. Pat. Nos. 11,054,999, 11,119,670, 11,126,356, 11,334,264, 11,662,924, and 12,061,807, the disclosures of which are incorporated by reference herein. For instance, with McEliece encryption, the IPK frame structure 400 coupled with a dynamic schedule can repeatedly modify any or all of the following: the matrix values, the encoding/decoding matrix type (such as LDPC, Goppa, BCH, or Reed-Solomon), and the asymmetric/symmetric mode of operation. A McEliece variant may further incorporate multiple instances of the scramble, encode, or permutation operations, for example, applying two layers of permutation, two rounds of encoding, or repeated scrambling, in sequence or parallel, to increase the cipher's robustness. These dynamic and modular modifications, including the possibility of layered transforms, significantly increase the computational burden for any attacker attempting to break the encrypted data, while maintaining the flexibility and security advantages of non-SPN, matrix-based cryptography.

In other embodiments, the MHE-S micro-architecture could be modified in a number of ways, including but not limited to the following: vary the block interconnections to streamline operations, combine block functions to optimize performance and efficiency, replicate block functions to parallelize operations to improve performance, remove individual block functions entirely or a subset of a particular block's functions to implement specific non-SPN ciphers that only require a subset of the full complement of the block functions, and leverage existing hardware to implement certain functions and supplement the dedicated hardware functions with software or firmware.

The primary computational engine for accelerating non-SPN ciphers, including but not limited to McEliece and all its variants, code-based schemes, and lattice-based schemes, is a hardware block dedicated to matrix multiplication paired with accumulation (referred to as a matrix multiply and accumulate function (MMA), multiply/accumulate, or MAC). One embodiment of the MHE-S micro-architecture uses the linear transformation block 142 to perform the matrix multiply function and the ALU block 144 to perform the accumulate function. MMAs are also at the core of graphics and AI processing. Many companies have embedded, optimized MMAs with varying degrees of parallelism depending on the application. GPUs use MMAs to parallelize tasks in areas such as graphics processing and rendering in addition to AI training. For GPUs, NVIDIA is an industry leader. NPUs use MMAs to accelerate AI and machine learning tasks, with an emphasis on neural network inference and training in more power constrained environments. For NPUs, NVIDIA, Intel, Qualcomm, Apple, and AMD are industry leaders. Some CPUs now include MMAs to enhance the performance of AI and machine learning workloads. For CPUs with MMAs, Intel is an industry leader. The abovementioned GPUs, NPUs and CPUs have intended functions such as graphics, AI, machine learning, deep learning, and neural networks, which are not related to security/obfuscation. In some embodiments, the MHE-S micro-architecture can be realized by leveraging the MMA functions that already exist in these processors. In other embodiments, the MHE-S micro-architecture may be implemented in MMA functions in hardware components not designed for graphics or AI, such as memory controllers, the chips that manage data flow between the processor and memory. Depending on the specific GPU, NPU or CPU capabilities and architecture, the other functions of the MHE-S micro-architecture may be leveraged in hardware when appropriate or implemented in software when necessary. In some embodiments, the MMA hardware could perform the matrix-based non-SPN security without the originally intended graphics or AI functions. In some embodiments, the MMA hardware could perform both the matrix-based non-SPN security and the graphics or AI functions simultaneously. Applicant's U.S. Pat. Nos. 11,054,999, 11,119,670, 11,126,356, 11,334,264, 11,662,924, and 12,061,807 cover instances where security/encryption is coupled to AI functions. The practical result is a flexible micro-architecture that can be optimized for cryptographic processing on existing silicon, with the option to supplement or extend functionality in software or firmware as needed for particular use cases or hardware platforms.

By leveraging these existing MMA capabilities, the MHE-S micro-architecture enables matrix-based non-SPN encryption to run at speeds and efficiencies that would be unattainable in software alone. This approach is especially powerful because it requires no fundamental redesign of the underlying hardware; instead, it adapts the MMA function, already present and heavily optimized for graphics and AI, to perform cryptographic operations. The invention thus offers unprecedented flexibility: the MMA hardware can be allocated entirely to cryptography, used in parallel for both cryptographic and traditional graphics or AI tasks, or dynamically partitioned according to system needs. This ability to repurpose and co-opt widely available computational resources for security represents a significant leap forward in practical, deployable hardware acceleration for next-generation cryptography. Furthermore, the integration with Applicant's patent portfolio, referenced above, illustrates that this repurpose can be extended to support dynamic, session-based encryption changes and even scenarios where security and AI functions are tightly coupled, a further demonstration of the invention's adaptability and forward-looking design. In some embodiments, minor modifications to existing and future processors can optimize the MMA for security.

FIG. 5 categorizes the system into matrix operations (142, 144, 146), key generation/storage (122, 124), data selection and routing (110, 120, 130, 135), and block control (105), clarifying both hardware/software/firmware options and system adaptability. The matrix operations category performs linear transformations, ALU, and scramble/permutation functions in hardware. The matrix multiply function is part of the linear transformation block 142 and the accumulate function is part of the ALU block 144. Depending on the specific micro-architecture of the GPUs, NPUs and CPUs, the embedded MMA may be a specific function or part of a block or group of blocks that perform additional linear transformation or arithmetic and logic operations. The matrix-based non-SPN encryption requirements will dictate the additional linear transformation, arithmetic and logic functions that may be leveraged in hardware versus software or firmware. This choice of hardware, software or firmware applies to the scramble/permutation functions, as well. The key generation and storage category contains memory 122 and PRNG 124 functions. Memory 122 will be available on the devices but the connection to the MMA may require assistance from software or firmware. If the devices contain PRNG 124, they can be leveraged when required for encryption; otherwise, external sources of PRNG 124 may be utilized. The data selection and routing category contains the matrix operations selector 135 and multiplexers 110, 120, and 130 (MUX 1, 2, & 3); these functions are micro-architecture specific and will require software or firmware control. The block function control category containing the sequencer functions is also micro-architecture dependent and will require software or firmware control. Whenever the optimal function blocks and interconnections are not implemented in hardware, there is an impact to the encryption performance.

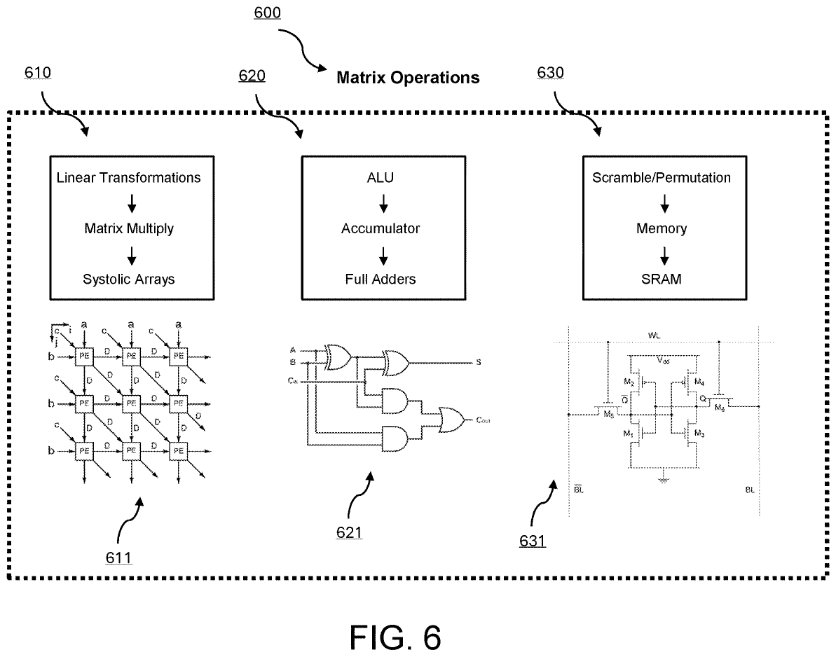

FIG. 6 highlights exemplary matrix operations 600 that may be implemented in hardware. Classic McEliece and its symmetric variant perform three operations (ECC encode, scramble, and permutation) that leverage fundamental functions that directly translate to hardware. The ECC encode operation may use a matrix multiply function 610, which is a linear transformation, and an accumulator function 620, which is an ALU function but also may be considered a linear transformation. The scramble and permutation operations may use memory 630, which may implement scrambling or permuting. An efficient hardware implementation of a matrix multiply/linear transformation is a systolic array 611 using complementary metal oxide semiconductor (CMOS) transistors. An efficient hardware implementation of an accumulator/ALU is a network of full adders 621, which may be realized as a feedback system of CMOS transmission and logic gates. An efficient hardware implementation of memory/scramble/permutation is an array of six CMOS transistor (6T) memory cells and supporting CMOS logic gates 631. Although the preferred embodiment of symmetric McEliece can leverage these hardware implementations, other non-SPN ciphers such as lattice-based ciphers (for example, Kyber and Dilithium) can leverage these hardware implementations 611, 621, and 631. In addition, SPN ciphers such as AES and Ascon can leverage one or more of these hardware implementations 611, 621, and 631. Successive changes to ciphers, matrix sizes and matrix values take advantage of these hardware implementations 611, 621, and 631, as well.

As used herein, the term “matrix operation” refers to any computational operation that takes as input, produces as output, or is performed upon data organized as one or more matrices, vectors, tensors, or other multi-dimensional arrays of elements, including without limitation linear-algebraic operations such as matrix multiply, matrix multiply and accumulate, matrix addition, matrix subtraction, change of basis, inner product, outer product, dot product, cross product, quantization, scaling, rotation, shearing, transpose, inversion, decomposition, and projection; arithmetic operations such as addition, subtraction, multiplication, division, modular arithmetic, and finite-field arithmetic performed element-wise or block-wise on matrix operands; logical operations such as bitwise AND, OR, XOR, NAND, NOR, and NOT performed element-wise or block-wise on matrix operands; bit-level operations such as bit shift, byte shift, bit reversal, byte reversal, bit rotation, and byte rotation performed on matrix operands; data-movement operations such as scrambling, permutation, shuffling, transposition of indices, and reordering of rows, columns, or elements of a matrix; and any combination, sequence, or composition of the foregoing. The term encompasses operations on matrices of any dimensionality and any size, including without limitation row vectors, column vectors, square matrices, rectangular matrices, sparse matrices, and dense matrices; operations on matrices whose elements are integers, real numbers, complex numbers, finite-field elements, modular residues, or symbolic expressions; operations on matrices that are orthogonal, unitary, Hermitian, symmetric, antisymmetric, triangular, diagonal, or arbitrary; and operations realized in dedicated hardware circuitry, software executing on a general-purpose processor, firmware, programmable logic, or any combination thereof.

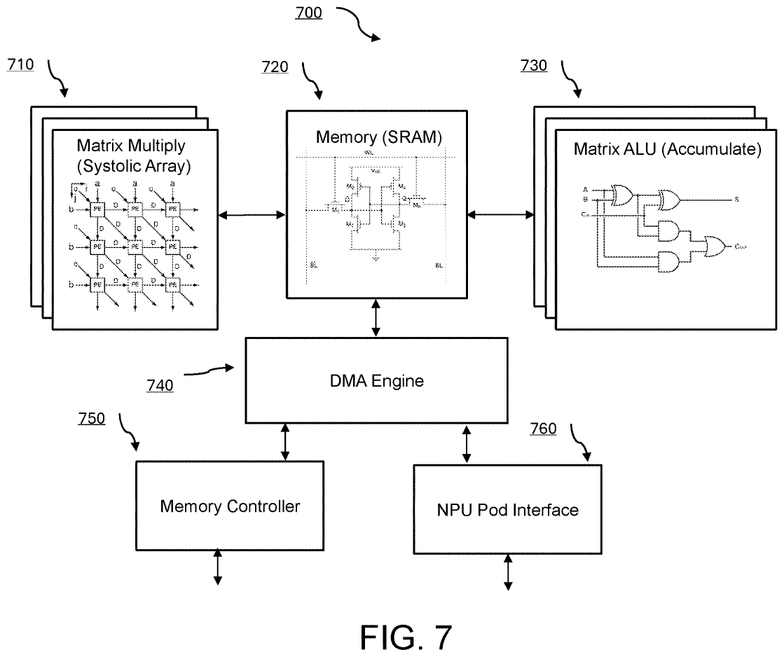

The primary function of an NPU is to accelerate machine learning (ML) workloads in hardware. FIG. 7 shows a generic NPU micro-architecture 700 to accomplish the ML workload acceleration. The fundamental processing functions include matrix multiply 710 and matrix ALU 730 which can perform vector or scalar operations on data. On-chip memory 720 is used by the on-chip matrix processing functions 710, 730 to optimize calculations. Also, memory 720 provides a connection to off-chip memory via a memory controller 750 via a direct memory access (DMA) engine 740 for storing ML weights. The NPU micro-architecture allows scaling through an NPU pod interface 760 by allowing multiple NPUs to operate in parallel. The matrix multiply 610 implementation as a systolic array correlates to the implementation for security 611. The matrix ALU 730 accumulator implementation as a full adder with transmission and logic gates correlates to the implementation for security 621. The memory 720 implementation as an array of 6T cells correlates to the implementation for security 631. The NPU micro-architecture 700 as well as other processor micro-architectures are conducive to encryption acceleration in addition to successive changes to ciphers, matrix sizes, or matrix values.

The systems and methods described herein have applicability beyond the primary embodiments described above. The MHE-S micro-architecture 100 may be deployed in any computing context in which matrix-based cryptographic operations are performed, including without limitation wired and wireless communication systems at any layer of the open systems interconnection model, data center storage and compute systems, embedded systems, mobile devices, automotive systems, internet-of-things devices, edge computing platforms, high-performance computing platforms, and platforms that combine cryptographic processing with one or more of graphics processing, artificial intelligence inference, artificial intelligence training, signal processing, and general-purpose computation. The successive encryption 200S and the successive decryption 250S are applicable to any context in which encryption parameters change across iterations of the encryption operation, including without limitation contexts in which the parameter changes are driven by a higher-layer protocol, by a security policy, by a real-time threat indicator, or by a randomization schedule.

The embodiments described herein are meant to illustrate the inventive concepts contained herein. Other embodiments and modifications may be made to the compositions and methods without departing from the spirit and scope of the invention. Therefore, the scope of the present invention should not be limited to the embodiments described herein but should be defined by the appended claims and their equivalents.

We claim:

1. A cryptographic hardware accelerator for encryption or decryption of data, comprising:
a matrix operations block configured to perform, in hardware, at least one of (i) a multiply/accumulate operation or (ii) a multiply and addition operation, as part of the encryption or decryption of a first unit of data and a second unit of data,
wherein the encryption or decryption of the first unit of data and the second unit of data uses, in the matrix block, at least one of (a) a first cipher and a second cipher, (b) a first matrix size and a second matrix size, or (c) a first set of matrix values and a second set of matrix values.

2. The cryptographic hardware accelerator of claim 1, wherein the first cipher is a McEliece cryptosystem comprising one or more of (a) an asymmetric McEliece cipher, (b) a symmetric McEliece cipher, or (c) a McEliece variant cipher.

3. The cryptographic hardware accelerator of claim 1, wherein the first cipher is AES.

4. The cryptographic hardware accelerator of claim 1, wherein the first cipher is a lattice-based non-substitution-permutation network cipher.

5. The cryptographic hardware accelerator of claim 1, further comprising at least one of (a) a sequencer implemented in hardware and configured to control the matrix operations block, (b) a scramble sub-block of the matrix operations block, the scramble sub-block being implemented in hardware and configured to perform a scramble operation on the data, or (c) a permutation sub-block of the matrix operations block, the permutation sub-block being implemented in hardware and configured to perform a permutation operation on the data.

6. The cryptographic hardware accelerator of claim 1, wherein the second cipher is different from the first cipher, the second matrix size is different from the first matrix size, or the second set of matrix values is different from the first set of matrix values.

7. The cryptographic hardware accelerator of claim 1, wherein the matrix operations block is implemented as part of a hardware core, a graphics processing unit (GPU), a digital signal processor (DSP), a neural processing unit (NPU), a central processing unit (CPU), a field-programmable gate array (FPGA), an application-specific integrated circuit (ASIC), a chiplet, a multi-chip module, a chip-stacking environment, or a memory controller.

8. The cryptographic hardware accelerator of claim 1, wherein the matrix operations block is assisted by one or more processor instructions.

9. A method for encryption or decryption of data, comprising:
performing, in hardware by a matrix operations block of a cryptographic hardware accelerator, at least one of (i) a multiply/accumulate operation or (ii) a multiply and addition operation, as part of the encryption or decryption of a first unit of data and a second unit of data, wherein the encryption or decryption of the first unit of data and the second unit of data uses, in the matrix operations block, at least one of (a) a first cipher and a second cipher, (b) a first matrix size and a second matrix size, or (c) a first set of matrix values and a second set of matrix values.

10. The method of claim 9, wherein the first cipher is a McEliece cryptosystem comprising one or more of (a) an asymmetric McEliece cipher, (b) a symmetric McEliece cipher, or (c) a McEliece variant cipher.

11. The method of claim 9, wherein the first cipher is AES.

12. The method of claim 9, wherein the first cipher is a lattice-based non-substitution-permutation network cipher.

13. The method of claim 9, further comprising at least one of (a) controlling the matrix operations block by a sequencer implemented in hardware, (b) performing, in hardware by a scramble sub-block of the matrix operations block, a scramble operation on the data, or (c) performing, in hardware by a permutation sub-block of the matrix operations block, a permutation operation on the data.

14. The method of claim 9, wherein the second cipher is different from the first cipher, the second matrix size is different from the first matrix size, or the second set of matrix values is different from the first set of matrix values.

15. The method of claim 9, wherein the matrix operations block is implemented as part of a hardware core, a graphics processing unit (GPU), a digital signal processor (DSP), a neural processing unit (NPU), a central processing unit (CPU), a field-programmable gate array (FPGA), an application-specific integrated circuit (ASIC), a chiplet, a multi-chip module, a chip-stacking environment, or a memory controller.

16. The method of claim 9, wherein the matrix operations block is assisted by one or more processor instructions.

17. A processor comprising:
a matrix multiply and accumulate hardware block configured to perform, in hardware, at least one of (i) a matrix multiply operation or (ii) a matrix multiply and accumulate operation,
wherein the matrix multiply and accumulate hardware block is configured to perform the at least one of (i) the matrix multiply operation or (ii) the matrix multiply and accumulate operation as part of both (a) at least one of a graphics processing function, an artificial intelligence function, a machine learning function, or a digital signal processing function, and (b) encryption or decryption of data, and
wherein the encryption or decryption of data uses, in the matrix multiply and accumulate hardware block, at least one of (a) a first cipher and a second cipher, (b) a first matrix size and a second matrix size, or (c) a first set of matrix values and a second set of matrix values.

18. The processor of claim 17, wherein the processor comprises at least one of a graphics processing unit, a neural processing unit, a digital signal processor, or a central processing unit extended with vector or tensor instructions.

19. The processor of claim 17, wherein the first cipher is a McEliece cryptosystem comprising one or more of (a) an asymmetric McEliece cipher, (b) a symmetric McEliece cipher, or (c) a McEliece variant cipher.

20. The processor of claim 17, wherein the first cipher is AES.
